(19) United States
(12) Patent Application Publication
(10) Pub. No.: US 2011/0196628 A1
(43) Pub. Date: Aug. 11, 2011

(54) DETERIORATION DETECTION CIRCUIT

(75) Inventor: Yasuhiro OSADA, Kanagawa (JP)

(73) Assignee: Renesas Electronics Corporation

(21) Appl. No.: 13/019,519

(22) Filed: Feb. 2, 2011

(30) Foreign Application Priority Data
Feb. 8, 2010 (JP) 2010-025330

(51) Int. Cl. G06F 19/00

(52) U.S. Cl. 702/58

(57) ABSTRACT

A deterioration detection circuit which accurately measures the degree of deterioration of a device (particularly a transistor) in a semiconductor integrated circuit. The deterioration detection circuit includes a frequency measuring instrument for outputting data on the frequency of a ring oscillator and a judgment circuit for deciding whether the ring oscillator is acceptable or not. The judgment circuit receives frequency data, environment-dependent characteristic data indicating the relation between the operating environment and oscillation frequency of the ring oscillator, tolerance data indicating the tolerable oscillation frequency range for the ring oscillator, and environment-specific data for the ring oscillator in operation. An ideal oscillation frequency for the ring oscillator is calculated based on the environment-specific data and environment-dependent characteristic data and a decision is made as to whether or not the frequency data is within the range corresponding to the tolerance data.

### CROSS-REFERENCE TO RELATED APPLICATIONS

The disclosure of Japanese Patent Application No. 2010-25330 filed on Feb. 8, 2010 including the specification, drawings and abstract is incorporated herein by reference in its entirety.

### BACKGROUND

1. Field of the Invention

The present invention relates to deterioration detection circuits for semiconductor integrated circuits and more particularly to a deterioration detection circuit for a semiconductor integrated circuit which can measure the degree of deterioration in the characteristics of a device

2. Description of Related Art

With the advance of data processing technology, there is a growing demand for more miniaturization, higher degrees of integration, and higher operation speeds of semiconductor integrated circuits. As for a miniaturized device in a semiconductor integrated circuit, its characteristics, such as threshold voltage Vt and mutual conductance gm, may fluctuate due to hot carriers, etc. A deterioration failure caused by a device characteristic fluctuation (deterioration) decreases the reliability of the semiconductor integrated circuit. Therefore, particularly when the semiconductor integrated circuit is used for a system which should not stop operation, such as a server, it is necessary to detect a deterioration and predict a failure during operation of the system. The following techniques are disclosed as techniques for detecting such deterioration failure.

Japanese Unexamined Patent Publication No. 2004-266243 describes a technique which generates an end-of-life flag before a failure occurs in an active IC, thereby reducing downtime of a system which uses the IC. In this technique, a failure caused by injection of hot carriers is predicted as follows: the frequency of a ring oscillator which is supposed to deteriorate due to injection of hot carriers is measured and if the decrease of the frequency is below a given threshold, a signal to indicate the existence of a failure is generated.

Japanese Unexamined Patent Publication No. Hei 9 (1997)-097874 describes a technique in which a semiconductor device capable of performing AC operation and making DC measurement is configured and the degree of deterioration caused by hot carriers can be evaluated accurately under an operating condition similar to an actual operating condition of the device. This technique uses two ring oscillators, a reference oscillator and a testing oscillator, in which the difference between the oscillation frequency of the testing ring oscillator and that of the reference ring oscillator is considered to indicate the degree of deterioration.

Japanese Unexamined Patent Publication No. Hei 9 (1997)-127186 describes a technique which detects deterioration of AC characteristics and thereby makes usable a device whose AC characteristics deteriorate. In this technique, the oscillation frequency of a ring oscillator is compared against a reference value previously stored in a memory to measure the degree of deterioration.

### SUMMARY

In the conventional techniques, the condition under which the characteristics of a ring oscillator are evaluated actually (for example, the temperature and/or operating voltage of the semiconductor integrated circuit (device) in operation) must be the same as the condition under which the ring oscillator characteristics stored in the memory are determined. However, it is very difficult to make constant the condition under which the characteristics are evaluated. This sometimes makes it difficult that when the frequency changes, the degree of deterioration of, for example, a transistor is evaluated properly depending on the frequency change. Also, when the frequency of the testing ring oscillator is compared against the frequency of the reference ring oscillator to measure the degree of deterioration, if the reference ring oscillator has some deterioration, it is difficult to make a judgment about deterioration accurately. In short, the conventional techniques have a problem that the degree of deterioration of a device in a semiconductor integrated circuit may not be detected accurately.

Next, means to solve the problem will be described using the same reference numerals as used in the “Detailed Description of the Preferred Embodiments”. These reference numerals are used below to clarify the relation between the appended claims and the preferred embodiments of the invention. However, the reference numerals should not be used to interpret the technical scope of the invention as described in the claims.

According to one aspect of the invention, in order to solve the above problem, there is provided a deterioration detection circuit (8) which is located in a semiconductor integrated circuit and includes a ring oscillator (1), a frequency measuring instrument (2) which measures an oscillation frequency of the ring oscillator (1) during its operation and outputs frequency data, and a judgment circuit (7) which decides whether the ring oscillator (1) is acceptable or not. Here, the judgment circuit (7) receives the frequency data, environment-dependent characteristic data (15), (16), (17) indicating a relation between an operating environment and an oscillation frequency of the ring oscillator (1), tolerance data (6) indicating a tolerable frequency range for the ring oscillator (1), and environment-specific data (13), (14) for the ring oscillator (1) in operation. Based on the environment-specific data (13), (14) and the environment-dependent characteristic data (15), (16), (17), the judgment circuit (7) calculates an ideal frequency as an ideal oscillation frequency for the ring oscillator (1) under a condition specified by the environment-specific data (13), (14) and decides whether or not the frequency data is within a range corresponding to the tolerance data (6).

In other words, in order to detect the degree of deterioration of a transistor, the judgment circuit 7 of the deterioration detection circuit 8 receives at least either of the measured voltage data and measured temperature data and calculates, from the voltage and temperature dependent characteristic data of the ring oscillator, an ideal oscillation frequency in a situation that there is no deterioration. Then, it calculates a lower limit of tolerable oscillation frequency from input tolerance lower limit data and the ideal oscillation frequency and compares the oscillation frequency of the ring oscillator against the lower limit of tolerable oscillation frequency, thereby enabling the deterioration detection circuit (8) to decide whether the transistor is acceptable or not.

According to a typical aspect of the present invention, the invention brings about an advantageous effect briefly outlined as follows: the degree of deterioration of a device (particularly a transistor) in a semiconductor integrated circuit can be measured accurately.

### BRIEF DESCRIPTION OF THE DRAWINGS

FIG. 1 is a block diagram which illustrates the constitution of a deterioration detection circuit according to a first embodiment of the invention;

FIG. 2 is a table showing an example of the structure of environment-dependent characteristic data stored in a memory; and

FIG. 3 is a block diagram which illustrates the constitution of a deterioration detection circuit according to a second embodiment of the invention.

### DETAILED DESCRIPTION OF THE PREFERRED EMBODIMENTS

Next, the preferred embodiments of the present invention will be described in detail referring to the accompanying drawings. In the drawings that illustrate the preferred embodiments, the same elements are designated by the same reference numerals and repeated descriptions of such elements are omitted.

### First Embodiment

### Constitution

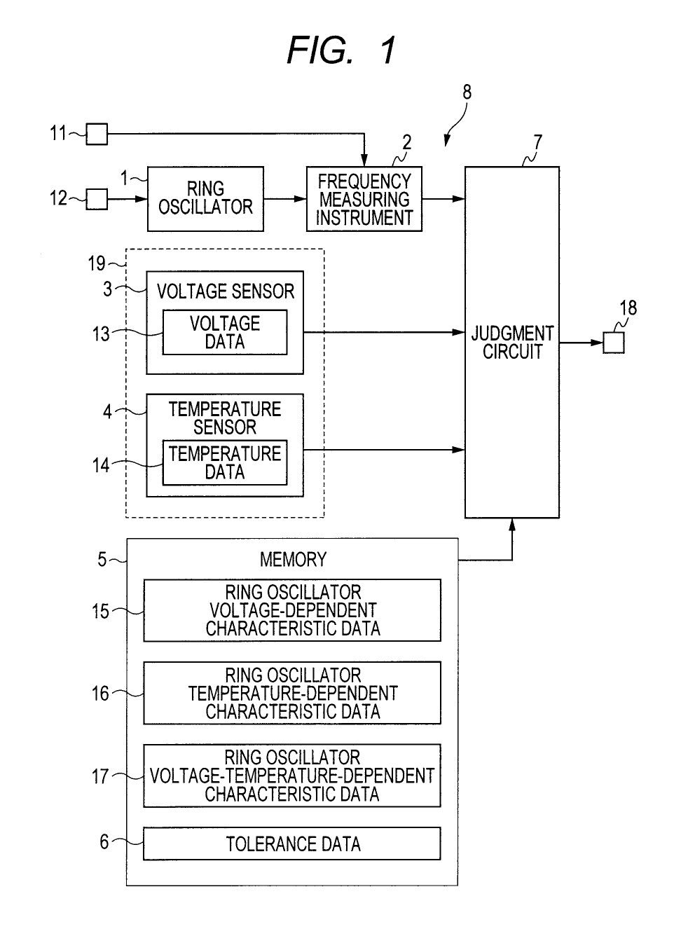

FIG. 1 is a block diagram which illustrates the constitution of a deterioration detection circuit 8 according to the first embodiment. The deterioration detection circuit 8 includes a ring oscillator 1, a frequency measuring instrument 2, a voltage sensor 3, a temperature sensor 4, a memory 5, and a judgment circuit 7. The frequency measuring instrument 2, typically a counter, measures the oscillation frequency of the ring oscillator 1. The voltage sensor 3 detects the voltage of the deterioration detection circuit 8, generates voltage data 13 and sends the voltage data 13 to the judgment circuit 7. The temperature sensor 4 detects the temperature of the deterioration detection circuit 8, generates temperature data 14 and sends the temperature data 14 to the judgment circuit 7.

The memory 5 stores tolerance data 6, ring oscillator voltage-dependent characteristic data 15, ring oscillator temperature-dependent characteristic data 16, and ring oscillator voltage-temperature-dependent characteristic data 17. The ring oscillator voltage-dependent characteristic data 15 indicates the relation between voltage and frequency. The ring oscillator temperature-dependent characteristic data 16 indicates the relation between temperature and frequency. The ring oscillator voltage-temperature-dependent characteristic data 17 indicates the relation of both voltage and temperature to frequency. The tolerance data 6 shows the lower limit of tolerance of deterioration. It is preferable that the memory 5, which stores the ring oscillator voltage-dependent characteristic data 15, ring oscillator temperature-dependent characteristic data 16, and ring oscillator voltage-temperature-dependent characteristic data 17, be a storage medium like a RAM, register, or ROM and such stored data be readable by the judgment circuit 7.

The judgment circuit 7 compares the oscillation frequency of the ring oscillator 1 as measured by the frequency measuring instrument 2 against the lower limit of tolerable frequency as obtained by calculation. The lower limit of tolerable frequency is calculated from the frequency of a non-deteriorating ring oscillator 1 (hereinafter referred to as “ideal oscillation frequency”) and tolerance data 6. When the judgment circuit receives at least either of voltage data 13 and temperature data 14, it calculates the ideal oscillation frequency in reference to at least any of the ring oscillator voltage-dependent characteristic data 15, ring oscillator temperature-dependent characteristic data 16, and ring oscillator voltage-temperature-dependent characteristic data 17.

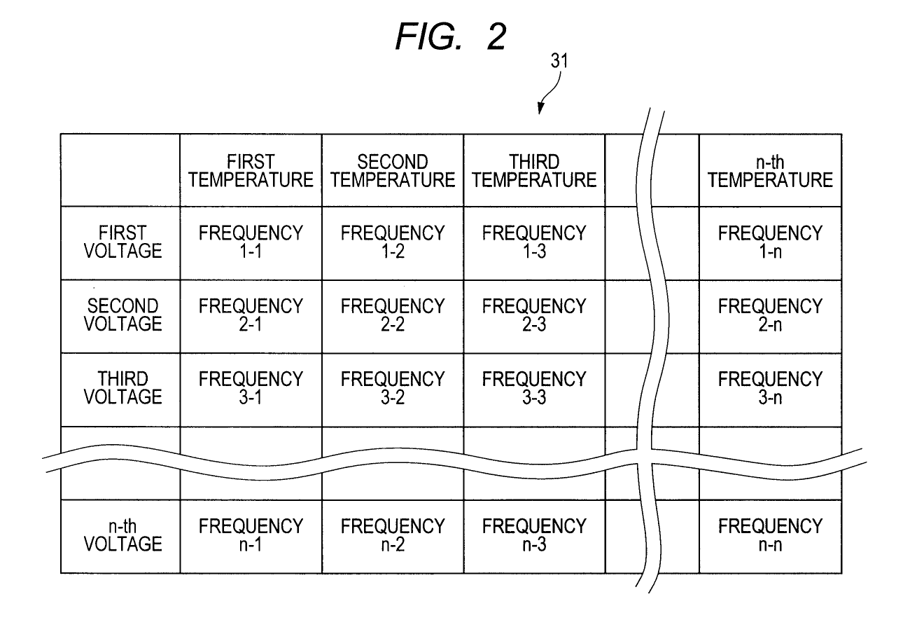

FIG. 2 is a table showing an example of the structure of environment-dependent characteristic data stored in the memory 5 (ring oscillator voltage-dependent characteristic data 15, ring oscillator temperature-dependent characteristic data 16, and ring oscillator voltage-temperature-dependent characteristic data 17). Particularly, FIG. 2 shows an example of the structure of voltage-temperature-dependent characteristic data 17 of the ring oscillator 1. The memory 5 stores frequency data in the form of a voltage-versus-temperature table as exemplified by Table 31. On the other hand, the voltage-dependent characteristic data 15 of the ring oscillator 1 will indicate frequencies corresponding to plural kinds of voltage data at a specific temperature. Similarly, the temperature-dependent characteristic data 16 of the ring oscillator 1 will indicate frequencies corresponding to plural kinds of temperature data at a specific voltage.

### Operation

Next, how the deterioration detection circuit 8 according to the first embodiment operates will be explained. Referring to FIG. 1, a control signal for enabling the ring oscillator 1 to oscillate is supplied from a control signal input terminal 11. In actual operation, the control signal to be supplied to the control signal input terminal 11 is controlled so that the ring oscillator 1 continues to oscillate. A reference signal for the frequency measuring instrument 2 is supplied from a reference signal input terminal 12. The reference signal is a pulse signal for the period from the start of counting until the end of counting. The frequency measuring instrument 2 sends the frequency fout of the ring oscillator 1 as counted in a given period to the judgment circuit 7.

An environment-specific data generating function block 19 measures at least either of the voltage and temperature of the deterioration detection circuit 8 and sends the measured voltage data 13 or temperature data 14 to the judgment circuit 7. The explanation given below is about a case that both the voltage data 13 and temperature data 14 are used.

In this case, the judgment circuit 7 receives voltage data 13 and temperature data 14. Also, the judgment circuit 7 reads the ring oscillator voltage-dependent characteristic data 15, ring oscillator temperature-dependent characteristic data 16, and ring oscillator voltage-temperature-dependent characteristic data 17. From those data, the judgment circuit 7 calculates the oscillation frequency in a situation that there is no deterioration (ideal oscillation frequency fref0). It identifies a tolerable frequency range fref based on the calculated ideal oscillation frequency fref0 and the tolerance data 6. Then, it checks the measured frequency fout of the ring oscillator 1 in reference to the tolerable frequency range fref. If the measured frequency fout is within the tolerable frequency range fref, the device is judged as acceptable and if it is out of the tolerable frequency range fref, the device is judged as unacceptable.

In the above case, the deterioration detection circuit 8 incorporates a voltage sensor 3. The voltage sensor 3 sends the result of measurement of the voltage supplied to the ring oscillator 1 as voltage data 13 to the judgment circuit 7. The deterioration detection circuit 8 incorporates a temperature sensor 4 and sends the result of measurement of the temperature of the ring oscillator 1 as temperature data 14 to the judgment circuit 7.

The deterioration detection circuit 8 according to this embodiment is not limited to the above constitution. Another example of the constitution may be as follows: the deterioration detection circuit 8 does not incorporate a voltage sensor 3 and the voltage supplied to the ring oscillator 1 is sent to a measuring instrument located outside the deterioration detection circuit 8 so that the voltage is measured using the external measuring instrument. Similarly, a further example of the constitution may be as follows: the deterioration detection circuit 8 does not incorporate a temperature sensor 4 and the temperature of the deterioration detection circuit 8 is measured using an external measuring instrument.

Furthermore, in the above case, the ring oscillator voltage-dependent characteristic data 15 and ring oscillator temperature-dependent characteristic data 16 of the ring oscillator 1 may be defined by a function with voltage or temperature as a parameter as expressed by Equation (1):

fref0=f(v,t) (1)

Furthermore, although the deterioration detection circuit 8 stores tolerance data 6 in the memory 5 in advance in the above case, it is not always necessary to store tolerance data 6 in the memory 5. Alternatively, tolerance data 6 may be specified from outside. Also, tolerance data 6 may be expressed as a percentage (%) of the ideal value or as an absolute value. Tolerance data 6 may consist of two or more tolerance ranges: for example, one tolerance range for deterioration which is tolerable but must be watched and another tolerance range for deterioration which is not tolerable.

As described above, in the deterioration detection circuit 8 according to this embodiment, the voltage supplied to the ring oscillator 1 and the temperature of the ring oscillator 1 are measured and its actual oscillation frequency is compared against the ideal oscillation frequency at the measured voltage and temperature. The degree of deterioration of the transistor can be thus accurately measured.

In the foregoing conventional technique which uses two ring oscillators, namely a reference ring oscillator and a testing ring oscillator, in order to determine the degree of deterioration, the difference between the oscillation frequency of the reference ring oscillator and that of the testing ring oscillator is measured. In this technique, deterioration of the reference ring oscillator itself is not taken into consideration. On the other hand, in the deterioration detection circuit 8 according to this embodiment, ring oscillator characteristic data for reference is stored in a memory or the like in advance and a judgment is made in reference to those data. This means that there is no deterioration in the oscillation frequency for reference.

### Second Embodiment

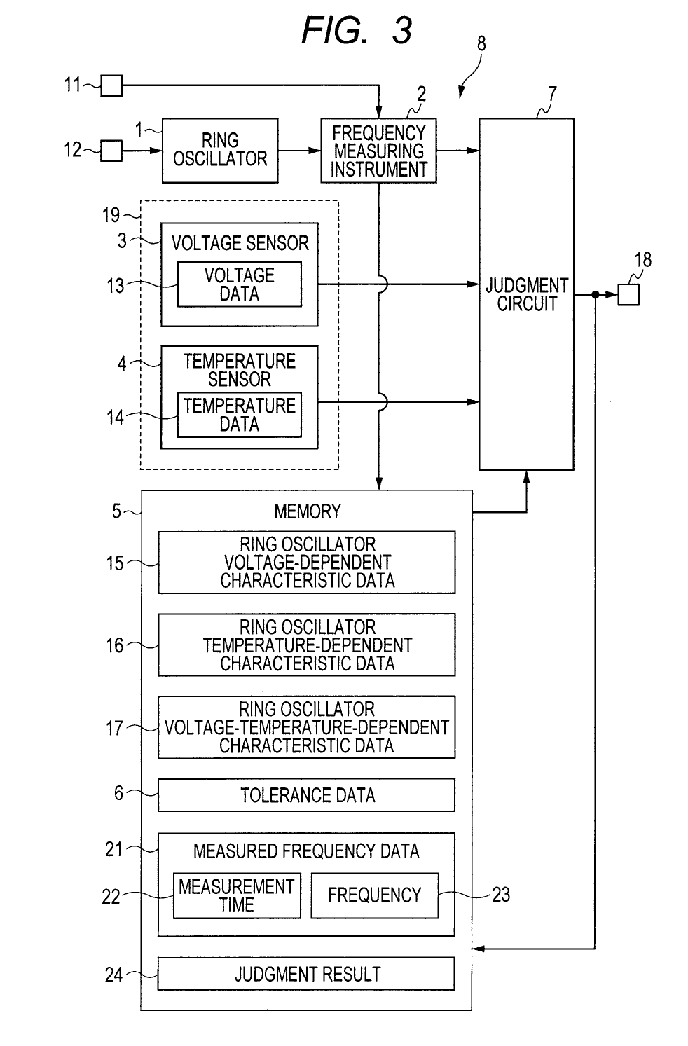

Next, a second embodiment of the present invention will be described referring to FIG. 3. FIG. 3 is a block diagram which illustrates the constitution of a deterioration detection circuit 8 according to the second embodiment. The deterioration detection circuit 8 according to the second embodiment measures the frequency of the ring oscillator 1 as the deterioration detection circuit 8 according to the first embodiment. In the second embodiment, the deterioration detection circuit 8 stores, in the memory 5, not only the measured frequency value but also the time when the measurement is made.

In the deterioration detection circuit 8 according to the second embodiment, after the judgment circuit 7 makes a judgment as to whether or not the measured frequency fout of the ring oscillator 1 is within the tolerable frequency range fref, it stores the judgment result in the memory 5. When the frequency of the ring oscillator 1 is measured, the judgment circuit 7 reads the past measurement results as well as voltage-dependent characteristic data and temperature-dependent characteristic data from the memory 5. Thus, the judgment circuit 7 can evaluate not only the degree of deterioration of the ring oscillator 1 but also the speed of deterioration.

So far the preferred embodiments of the present invention have been described concretely. However, the invention is not limited thereto and may be embodied in other various ways without departing from the spirit and scope thereof.

What is claimed is:

1. A deterioration detection circuit included in a semiconductor integrated circuit, the deterioration detection circuit comprising:
a ring oscillator;
a frequency measuring instrument which measures an oscillation frequency of the ring oscillator during its operation and outputs frequency data; and
a judgment circuit which decides whether the ring oscillator is acceptable or not,
wherein the judgment circuit receives:
the frequency data;
environment-dependent characteristic data indicating a relation between an operating environment of the ring oscillator and an oscillation frequency of the ring oscillator;
tolerance data indicating a tolerable frequency range for the ring oscillator; and
environment-specific data for the ring oscillator in operation,
wherein the judgment circuit calculates, based on the environment-specific data and the environment-dependent characteristic data, an ideal frequency as an ideal oscillation frequency for the ring oscillator under a condition specified by the environment-specific data and decides whether or not the frequency data is within a range corresponding to the tolerance data.

2. The deterioration detection circuit according to claim 1, wherein the judgment circuit identifies a tolerable frequency range for the ring oscillator, based on the ideal frequency and the tolerance data and decides whether or not the frequency data is within the tolerable frequency range.

3. The deterioration detection circuit according to claim 2,
wherein the environment-specific data is at least either of voltage data and temperature data;
wherein the voltage data indicates a voltage supplied to the ring oscillator; and
wherein the temperature data indicates a temperature of the ring oscillator.

4. The deterioration detection circuit according to claim 3,
wherein, when the operating environment refers to a voltage supplied to the ring oscillator, the environment-dependent characteristic data indicates a relation between change in the voltage and an oscillation frequency of the ring oscillator in normal operation;
wherein, when the operating environment refers to a temperature of the ring oscillator, the environment-dependent characteristic data indicates a relation between change in the temperature and an oscillation frequency of the ring oscillator in normal operation; and
wherein, when the operating environment refers to both a voltage supplied to the ring oscillator and a temperature of the ring oscillator, the environment-dependent characteristic data indicates a relation of both change in the voltage and change in the temperature to an oscillation frequency of the ring oscillator in normal operation.

5. The deterioration detection circuit according to claim 1, further comprising:
an environment-specific data generating function block which outputs the environment-specific data; and
a memory,
wherein the memory stores the environment-dependent characteristic data and the tolerance data.

6. The deterioration detection circuit according to claim 5,
wherein the environment-specific data generating function block at least includes either a voltage sensor or a temperature sensor;
wherein the voltage sensor outputs the voltage data; and
wherein the temperature sensor outputs the temperature data.

7. The deterioration detection circuit according to claim 1,
wherein the judgment circuit:
stores a result of judgment as to whether or not an oscillation frequency of the ring oscillator in operation is within the identified tolerable frequency range;
reads the result of judgment when it decides whether a future oscillation frequency of the ring oscillator is within a future tolerable frequency range; and
decides a degree of deterioration of the ring oscillator in reference to the result of judgment.

8. A semiconductor integrated circuit including the deterioration detection circuit according to claim 1.
